(19) United States
(12) Patent Application Publication
(10) Pub. No.: US 2017/0174802 A1
(43) Pub. Date: Jun. 22, 2017

(54) COPOLYMER AND MOLDED ARTICLE

(71) Applicant: KURARAY CO., LTD., Kurashiki-shi (JP)

(72) Inventors: Atsuhiro NAKAHARA, Tainai-shi (JP); Takashi FUKUMOTO, Tainai-shi (JP); Hiroyuki KONISHI, Kurashiki-shi (JP)

(73) Assignee: KURARAY CO., LTD., Kurashiki-shi (JP)

(21) Appl. No.: 15/116,144

(22) PCT Filed: Feb. 3, 2015
(86) PCT No.: PCT/JP2015/052930

§ 371 Date: Aug. 2, 2016

(30) Foreign Application Priority Data
Feb. 3, 2014 (JP) 2014-018434

(51) Int. Cl. C08F 220/14; C08J 5/18

(52) U.S. Cl. CPC C08F 220/14; C08J 5/18; C08J 2333/12

(57) ABSTRACT

A copolymer comprising structural units derived from a monomer represented by formula (1) and structural units derived from another monomer (A). (In formula (1), ring Z1 represents a C3-10 ring structure optionally having an oxygen atom at any position formed together with two carbon atoms on γ-butyrolactone. R1 represents a hydrogen atom or C1-10 alkyl group.

### TECHNICAL FIELD

The present invention relates to a copolymer which has high heat resistance, has low water absorbency, is less likely to be thermally decomposed, and has a high elastic modulus, and a molded article containing the copolymer.

### BACKGROUND ART

A methacrylic resin has high transparency, and therefore is useful as a material of a molded article to be used for an optical member, a lighting member, a sign board member, a decoration member, or the like. However, a methacrylic resin as a material of a molded article generally has a low glass transition temperature of about 110° C. Due to this, a molded article composed of the methacrylic resin is likely to be deformed by heat.

In order to impart heat resistance to a methacrylic resin, a large number of polymerizable monomers to serve as an effective copolymerization component have been developed. However, a polymerizable monomer which has been used conventionally is required to be used in a large amount obtaining sufficient heat resistance. Due to this, many the copolymers obtained by using such a polymerizable monomer have various problems such that they become brittle, are colored, etc. in return for the acquisition of heat resistance. Therefore, in order not to cause problems of brittleness and coloration, a polymerizable monomer capable of imparting excellent heat resistance in a smaller amount has been awaited.

For example, it is possible to obtain a copolymer having high heat resistance by polymerization or copolymerization of α-methylene-γ-butyrolactone (PTL 1, PTL 2, and NPL 1). However, a homopolymer of α-methylene-γ-butyrolactone has a glass transition temperature of 200° C. or lower, which cannot be said to be sufficient. In addition, the (co)polymer to be obtained has high water absorbency. In addition, a copolymer having a high glass transition temperature can be obtained by using a monomer described in PTL 3, however, also this copolymer has a problem that the water absorbency is high.

### CITATION LIST

### Patent Literature

PTL 1: WO 2006-025360
PTL 2: Japanese Patent No. 3649477
PTL 3: JP-A-2013-227496

### Non Patent Literature

NPL 1: Macromolecules, 1979, 12, 546-551

### SUMMARY OF INVENTION

### Technical Problem

An object is to provide a copolymer which shows extremely excellent heat resistance, has low water absorbency, is less likely to be thermally decomposed, and has a high elastic modulus while suppressing the problems of brittleness and coloration using an appropriate amount of a polymerizable monomer which imparts heat resistance.

### Solution to Problem

According to the invention, the above object is achieved by the following aspects.

[1] A copolymer composed of a structural unit derived from a monomer represented by the following formula (1) and a structural unit derived from another monomer (A).

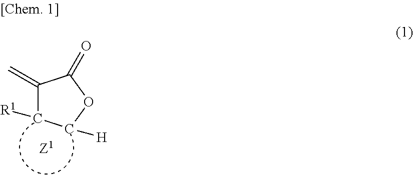

(In the formula (1), the ring Z¹ represents a C3-10 ring structure optionally having an oxygen atom at any position formed together with two carbon atoms on γ-butyrolactone, and R¹ represents a hydrogen atom or a C1-10 alkyl group.)

[2] The copolymer according to [2], wherein the other monomer (A) contains at least a methacrylic acid ester.

[3] The copolymer according to [1] or [2], wherein the structural unit derived from the monomer represented by the formula (1) is contained in an amount of 12 to 70 mass %.

[4] A molded article containing the copolymer according to any one of [1] to [3].

### Advantageous Effects of Invention

The copolymer of the invention has high heat resistance, has low water absorbency, and is less likely to be thermally decomposed. From the copolymer of the invention, a molded article which has high transparency and favorable dimensional stability can be obtained.

### DESCRIPTION OF EMBODIMENTS

The copolymer of the invention is characterized by containing a structural unit derived from a monomer represented by the formula (1). The monomer represented by the formula (1) has another ring structure containing two carbon atoms in the 5-membered ring of α-methylene-γ-butyrolactone, and therefore not only can impart high heat resistance to the copolymer to be obtained, but also can decrease the water absorbency as compared with α-methylene-γ-butyrolactone. Further, since the carbon atom which is adjacent to the oxygen atom in the 5-membered ring of α-methylene-γ-butyrolactone and constitutes the ring structure of Z¹ is a secondary carbon atom, the thermal decomposition resistance is not deteriorated. If this carbon atom is a tertiary carbon atom, the thermal decomposition resistance of the copolymer to be obtained is deteriorated, resulting in limiting the molding temperature.

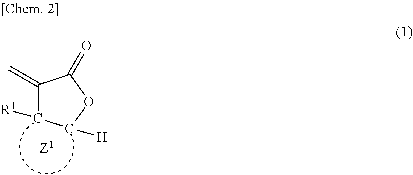

(In the formula (1), the ring Z¹ represents a C3-10 ring structure optionally having an oxygen atom at any position formed together with two carbon atoms on 7-butyrolactone, and R¹ represents a hydrogen atom or a C1-10 alkyl group.

The copolymer of the invention contains the monomer represented by the formula (1) in an amount of preferably 5 to 99 mass %, more preferably 8 mass % to 80 mass %, particularly preferably 12 mass % to 70 mass %. Specific examples of the monomer represented by the formula (1) include hexahydro-3-methylene-2H-cyclopenta[b]furan-2-one, hexahydro-3-methylene-2(3H)-benzofuranone, octahydro-3-methylene-2H-cyclohepta[b]furan-2-one, octahydro-3-methylene-cycloocta[b]furan-2(3H)-one, hexahydro-3-methylene-4,7-methanobenzofuran-2(3H)-one, 4-methylene-2,7-dioxabicyclo[3.3.0]octan-3-one, 4-methylene-3-oxatetracyclo[7.3.1^{6,12}.0^{7,11}]-3-one, and 4-methylene-2,6-dioxabicyclo[3.3.0]octan-3,7-dione. Among these, from the viewpoint that the production can be performed at low cost and the polymerizability is favorable, hexahydro-3-methylene-2H-cyclopenta[b]furan-2-one, hexahydro-3-methylene-2(3H)-benzofuranone and 4-methylene-3-oxatetracyclo[7.3.1^{6,12}.0^{7,11}]-3-one are preferred, and hexahydro-3-methylene-2(3H)-benzofuranone is most preferred.

The other monomer to be copolymerized with the monomer represented by the formula (1) (hereinafter sometimes referred to as “the other monomer (A)”) is not particularly limited as long as it can be copolymerized with the monomer represented by the formula (1). In the case where a structural unit derived from the other monomer (A) is contained in the copolymer of the invention, the structural unit derived from the other monomer (A) is contained in an amount of preferably 1 mass % to 95 mass % more preferably 20 mass % to 90 mass % particularly preferably 30 mass % to 88 mass %.

When the content of the other monomer (A) is decreased and the content of the monomer represented by the formula (1) is increased, the copolymer of the invention tends to have extremely high heat resistance. The content of the other monomer (A) may be appropriately set according to the physical properties of the copolymer to be obtained.

Examples of the other monomer (A) include vinyl aromatic hydrocarbons such as styrene, α-methylstyrene, p-methylstyrene, and m-methylstyrene; vinyl aliphatic hydrocarbons such as vinylcyclohexane, vinylcyclopentane, vinylcyclohexene, vinylcycloheptane, vinylcyclohepcene, and vinyl norbornene; ethylenically unsaturated carboxylic acids such as maleic anhydride, maleic acid, and itaconic acid; olefins such as ethylene, propylene, 1-butene, isobutylene, and 1-octene; conjugated dienes such as butadiene, isoprene, and myrcene; acrylamide, methacrylamide, acrylonitrile, methacrylonitrile, vinyl acetate, vinyl ketone, vinyl chloride, vinylidene chloride, vinylidene fluoride; alkyl methacrylic acid esters such as methyl methacrylate, ethyl methacrylate, and butyl methacrylate; aryl methacrylic acid esters such as phenyl methacrylate; cycloalkyl methacrylic acid esters such as cyclohexyl methacrylate, 2-isobornyl methacrylate, 8-tricyclo[5.2.1.0^{2,6}]decanyl methacrylate, 2-norbornyl methacrylate, and 2-adamantyl methacrylate; (alkyl methacrylic acid esters, aryl methacrylic acid esters, and cycloalkyl methacrylic acid esters are collectively referred to as methacrylic acid esters); alkyl acrylic acid esters such as methyl acrylate, ethyl acrylate, n-propyl acrylate, isopropyl acrylate, n-butyl acrylate, isobutyl acrylate, s-butyl acrylate, t-butyl acrylate, amyl acrylate, isoamyl acrylate, n-hexyl acrylate, 2-ethyl hexyl acrylate, pentadecyl acrylate, and dodecyl acrylate; acrylic acid derivatives such as 2-hydroxyethyl acrylate, 2-ethoxyethyl acrylate, glycidyl acrylate, allyl acrylate, and benzyl acrylate; α-methylene-γ-butyrolactone derivatives other than the monomers represented by the formula (1) used in the invention such as α-methylene-γ-butyrolactone, α-methylene-4-methyl-γ-butyrolactone, α-methylene-4-ethyl-γ-butyrolactone, α-methylene-4-t-butyl-γ-butyrolactone, α-methylene-4-undecyl-γ-butyrolactone, α-methylene-4,4-dimethyl-γ-butyrolactone, α-methylene-4-methyl-4-ethyl-γ-butyrolactone, α-methylene-4,4-diethyl-γ-butyrolactone, α-methylene-4,4-diisopropyl-γ-butyrolactone, α-methylene-4-phenyl-γ-butyrolactone, α-methylene-4-phenyl-4-methyl-γ-butyrolactone, α-methylene-4,4-diphenyl-γ-butyrolactone, α-methylene-4-cyclohexyl-γ-butyrolactone, α-methylene-4-trifluoromethyl-γ-butyrolactone, α-methylene-4-perfluoroethyl-γ-butyrolactone, and α-methylene-4,4-ditrifluoromethyl-γ-butyrolactone; ethylenically unsaturated heterocyclic compound such as 2-vinylfuran, 2-isopropenylfuran, 2-vinylbenzofuran, 2-isopropenylbenzofuran, 2-vinyldibenzofuran, 2-vinylthiophene, 2-isopropenylthiophene, 2-vinyldibenzothiophene, 2-vinylpyrrole, N-vinylindole, N-vinylcarbazole, 2-vinyloxazole, 2-isopropenyloxazole, 2-vinylbenzoxazole, 3-vinylisoxazole, 3-isopropenylisoxazole, 2-vinylthiazole, 2-vinylimidazole, 4(5)-vinylimidazole, N-vinylimidazole, N-vinylimidazoline, 2-vinylbenzimidazole, 5(6)-vinylbenzimidazole, 5-isopropenylpyrazole, 2-isopropenyl1,3,4-oxadiazole, vinyltetrazole, 2-vinylpyridine, 4-vinylpyridine, 2-isopropenylpyridine, 3-vinylpyridine, 3-isopropenylpyridine, 2-vinylquinoline, 2-isopropenylquinoline, 4-vinylquinoline, 4-vinylpyrimidine, 2,4-dimethyl-6-vinyl-S-triazine, 3-methylidenedihydrofuran-2(3H)-one, 4-methyl-3-methylidenedihydrofuran-2 (3H)-one, and 4-decyl-3-methylidenedihydrofuran-2 (3H)-one; and phosphoric acid esters having an ethylenically unsaturated group such as dimethylmethacryloyloxy methylphosphate and 2-methacryloyloxy-1-methylethylphosphate. Among these, from the viewpoint that the copolymerizability with the monomer represented by the formula (1) is favorable and the transparency and heat resistance of the copolymer are excellent, methacrylic acid esters are preferred, and in pa ocular, alkyl methacrylic acid esters are more preferred, and specifically, methyl methacrylate is most preferred.

The weight average molecular weight of the copolymer of the invention is preferably from 40,000 to 300,000, more preferably from 60,000 to 250,000, particularly preferably from 80,000 to 200,000. When the weight average molecular weight is too low, the strength is decreased. When the weight average molecular weight too high, molding becomes difficult.

The ratio of the weight average molecular weight to the number average molecular weight (hereinafter this ratio is referred to as “molecular weight distribution”) of the copolymer of the invention is preferably from 1.01 to 3.0, more preferably 1.05 to 2.5, further more preferably from 1.10 to 2.2. When the molecular weight distribution is within this range, a copolymer having favorable moldability can be obtained. The weight average molecular weight and the molecular weight distribution are values in terms of standard polystyrene measured by GPC (gel permeation chromatography).

The weight average molecular weight and the molecular weight distribution can be controlled by adjusting the type, amount, and the like of a polymerization initiator and a chain transfer agent in the polymerization reaction.

The glass transition temperature of the copolymer of the invention is preferably from 120 to 350° C., more preferably from 130 to 250° C. When the glass transition temperature is too low, the heat resistance of the copolymer is insufficient, and an application which can be used is limited. When the glass transition temperature is too high, the copolymer becomes brittle and is easily broken. Incidentally, the glass transition temperature is a value measured in accordance with JIS K 7121. That is, a DSC curve was measured by differential scanning calorimetry under the conditions that the copolymer of the invention was once heated to 270° C., and then cooled to room temperature, and thereafter heated from room temperature to 270° C. at 10° C./min, and a midpoint glass transition temperature obtained from the DSC curve measured in the second heating was determined to be the glass transition temperature of the invention.

A method for producing the copolymer of the invention is not particularly limited. In general, a method for producing the copolymer by adopting a radical polymerization method, and adjusting the polymerization temperature, the polymerization time, the type and amount of a chain transfer agent, the type and amount of a polymerization initiator, etc. is preferred from the viewpoint of productivity. Further, the monomer represented by the formula (1) also enables anionic polymerization, and therefore, in the case where a block copolymer or a copolymer with high stereoregularity is desired to be obtained, it is also possible to adopt an anionic polymerization method.

In a radical polymerization method for producing the copolymer of the invention, the production is preferably performed without a solvent or in a solvent, and from the viewpoint that a copolymer with a low impurity concentration can be obtained, the production is preferably performed without a solvent. From the viewpoint of suppressing the occurrence of silver or coloration in a molded article, it is preferred to perform the polymerization reaction by decreasing the amount of dissolved oxygen in a polymerization reaction starting material. Further, the polymerization reaction is preferably performed in an inert gas atmosphere such as nitrogen gas.

The polymerization initiator to be used in the radical polymerization method for producing the copolymer of the invention is not particularly limited as long as it generates a reactive radical. Examples thereof include t-hexylperoxyisopropyl monocarbonate, t-hexylperoxy-2-ethyl hexanoate, 1,1,3,3-tetramethylbutylperoxy-2-ethyl hexanoate, t-butyl peroxypivalate, t-hexyl peroxypivalate, t-butyl peroxyneodecanoate, t-hexyl peroxyneodecanoate, 1,1,3,3-tetramethylbutyl peroxyneodecanoate, 1,1-bis(t-hexylperoxy) cyclohexane, benzoyl peroxide, 3,5,5-trimethylhexanoyl peroxide, lauroylperoxide, 2,2′-azobis(2-methylpropionitrile), 2,2′-azobis(2-methylbutyronitrile), and dimethyl 2,2′-azobis(2-methylpropionate). Among these, t-hexylperoxy-2-ethyl hexanoate, 1,1-bis(t-hexylperoxy) cyclohexane, and dimethyl 2,2′-azobis(2-methylpropionate) are preferred.

The one-hour half-life temperature of the polymerization initiator is preferably from 60 to 140° C., more preferably from 80 to 120° C. Further, the hydrogen abstraction ability of the polymerization initiator to be used for producing the copolymer is preferably 20% or less, more preferably 10% or less, further more preferably 5% or less. Among such polymerization initiators, one type can be used alone or two or more types can be used in combination. The amount of the polymerization initiator used is preferably from 0.0001 to 0.02 parts by mass, more preferably from 0.001 to 0.01 parts by mass, further more preferably from 0.005 to 0.007 parts by mass with respect to 100 parts by mass of the monomer to be subjected to the polymerization reaction.

The hydrogen abstraction ability can be known from the technical data of polymerization initiator manufacturers (for example, “Hydrogen abstraction ability of organic peroxides and initiator efficiency”, NOF Corporation Technical Data (created on April, 2003)) and the like. Further, it can be determined by a radical trapping method using an α-methylstyrene dimer, that is, an α-methylstyrene dimer trapping method. The measurement is generally performed as follows. First, a polymerization initiator is cleaved in the coexistence of an α-methylstyrene dimer as a radical trapping agent to produce radical fragments. Among the radical fragments produced, a radical fragment with a low hydrogen abstraction ability is trapped by being added to the double bond of the α-methylstyrene dimer. On the other hand, a radical fragment with a high hydrogen abstraction ability abstracts hydrogen from cyclohexane to generate a cyclohexyl radical, and the cyclohexyl radical is trapped by being added to the double bond of the α-methylstyrene dimer to produce a cyclohexane-trapped product. Therefore, the ratio (molar fraction) of the radical fragments with a high hydrogen abstraction ability to the theoretical production amount of the radical fragments, which can be determined by quantifying cyclohexane or the cyclohexane-trapped product, is defined as the hydrogen abstraction ability.

Examples of the chain transfer agent to be used in the case where a radical polymerization method is selected for producing the copolymer of the invention include alkyl mercaptans such as n-octyl mercaptan, n-dodecyl mercaptan, t-dodecyl mercaptan, 1,4-butanedithiol, 1,6-hexanedithiol, ethylene glycol bisthiopropionate, butanediol bisthioglycolate, butanediol bisthiopropionate, hexanediol bisthioglycolate, hexanediol bisthiopropionate, trimethylolpropane tris(β-thiopropionate), and pentaerythritol tetrakisthiopropionate. Among these, monofunctional alkyl mercaptans such as n-octyl mercaptan and n-dodecyl mercaptan are preferred. Among these chain transfer agents, one type can be used alone or two or more types can be used in combination.

The amount of the chain transfer agent used is preferably from 0.1 to 1 part by mass, more preferably from 0.15 to 0.8 parts by mass, further more preferably from 0.2 to 0.6 parts by mass, most preferably from 0.2 to 0.5 parts by mass with respect to 100 parts by mass of the monomer to be subjected to the polymerization reaction. Further, the amount of the chain transfer agent used is preferably from 2,500 to 10,000 parts by mass, more preferably from 3,000 to 9,000 parts by mass, further more preferably from 3,500 to 6,000 parts by mass with respect 100 parts by mass of the polymerization initiator. By setting the amount of the chain transfer agent used within the above range, the molecular weight of the copolymer to be obtained can be controlled, and therefore, favorable molding processability and high mechanical strength can be imparted to the copolymer to be obtained.

In the case where a solvent is used when a radical polymerization method is selected for producing the copolymer of the invention, the solvent is not limited as long as it can dissolve the monomer and the copolymer, however, aromatic hydrocarbons such as benzene, toluene, and ethyl benzene are preferred. Among these solvents, one type can be used alone or two or more types can be used in combination. The amount of the solvent used can be appropriately set from the viewpoint of the viscosity the reaction mixture and the productivity. The amount of the solvent used is, for example, preferably 100 parts by mass or less, more preferably 90 parts by mass with respect to 100 parts by mass of the polymerization reaction starting material.

In the case where a radical polymerization method is selected for producing the copolymer of the invention, the temperature in the polymerization reaction is preferably from 100 to 200° C., more preferably from 110 to 180° C. When the polymerization temperature is 100° C. or higher, the productivity tends to be improved owing to the improvement of the polymerization rate, the reduction in the viscosity of the polymerization mixture. Further, since the polymerization temperature is 200° C. or lower, the control of the polymerization rate is facilitated, and further, the production of byproducts is suppressed, and therefore, the coloration of the copolymer of the invention can be suppressed. The polymerization reaction time is preferably from 0.5 to 4 hours, more preferably from 1.5 to 3.5 hours, further more preferably from 1.5 to 3 hours. Incidentally, in the case of a continuous flow reactor, such a polymerization reaction time is an average retention time in the reactor. When the temperature in the polymerization reaction and the polymerization reaction time are within the above ranges, a copolymer having excellent transparency can be produced with high efficiency.

The radical polymerization may be performed using a batch reactor, but is preferably performed using a continuous flow reactor from the viewpoint of productivity. In a continuous flow reaction, for example, a polymerization reaction starting material (which is a mixed liquid containing monomers (which mean the monomer represented by the formula (1) and the other monomer (A) (as the other monomer (A), specifically, an alkyl methacrylic acid ester is preferred)), a polymerization initiator, a chain transfer agent, and the like) is prepared in a nitrogen atmosphere or the like, and the resulting material is fed to a reactor at a constant flow rate, and a liquid in the reactor is extracted at a flow rate corresponding to the feeding rate. As the reactor, a tubular reactor which can be brought to a state close to a plug flow state and/or a tank reactor which can be brought to a state close to a completely mixed state. In addition, continuous flow polymerization may be performed by one reactor, or may be performed by connecting two or more reactors.

In the invention, it is preferred to adopt a continuous flow tank reactor as at least one reactor. The liquid amount in the tank reactor in the polymerization reaction preferably from ¼ to ¾, more preferably from ⅓ to ⅔ the volume of the tank reactor. The reactor is generally equipped with a stirrer. Examples of the stirrer include a static stirrer and a dynamic stirrer. Examples of the dynamic stirrer include a Maxblend stirrer, a stirrer with a lattice-shaped blade rotating around a vertical rotation axis arranged in the center, a propeller stirrer, and a screw stirrer. Among these, a Maxblend stirrer is preferably used from the viewpoint of uniform mixing performance.

In the case where a radical polymerization method is selected for producing the copolymer of the invention, the polymerization conversion ratio when suspension polymerization is performed using a batch reactor is preferably from 50 to 100 mass %, more preferably from 70 to 99 mass %.

Further, the polymerization conversion ratio when a continuous flow tank reactor is used is preferably from 20 to 80 mass %, more preferably from 30 to 70 mass %, further more preferably from 35 to 65 mass %. When the polymerization conversion ratio is 20 mass % or more, it is easy remove residual unreacted monomers and the appearance of the molded article composed of the copolymer tends to be favorable. Further, when the polymerization conversion ratio is 70 mass % or less, the viscosity of the polymerization mixture decreased, and the productivity tends to be improved.

After completion of the polymerization, according to need, volatile components such as unreacted monomers are removed. The removal method is not particularly limited, however, heating devolatilization is preferred. Examples of the devolatilization method include an equilibrium flash process and an adiabatic flash process. The devolatilization temperature in the adiabatic flash process is preferably from 200 to 280° C., more preferably from 220 to 260° C. The time of heating a resin in the adiabatic flash process is preferably from 0.3 to 5 minutes, more preferably from 0.4 to 3 minutes, further more preferably from 0.5 to 2 minutes. When devolatilization is performed in such a temperature range for such a heating time, a copolymer which is less colored is easily obtained. The removed unreacted monomers can be recovered and used again in the polymerization reaction. The yellow index of the recovered monomers may sometimes be increased due to heat applied in the recovery operation or the like, and therefore, it is preferred to purify the recovered monomers by an appropriate method so as to decrease the yellow index.

In the production of the molded article of the invention, molding may be performed by mixing another polymer in the copolymer of the invention within the range not impairing the effect of the invention. Examples of the other polymer include polyolefin resins such as polyethylene, polypropylene, polybutene-1, poly-4-methylpentene-1, and polynorbornene; ethylene-based ionomers; styrene-based resins such as polystyrene, a styrene-maleic anhydride copolymer, high impact polystyrene, an AS resin, an ABS resin, an AES resin, an AAS resin, an ACS resin, and an MES resin; a methyl methacrylate-based polymer, a methyl methacrylate-styrene copolymer; polyester resins such as polyethylene terephthalate and polybutylene terephthalate; polyamides such as nylon 6, nylon 66, and a polyamide elastomer; polycarbonate, polyvinyl chloride, polyvinylidene chloride, polyvinyl alcohol, an ethylene-vinyl alcohol copolymer, polyacetal, polvinylidene fluoride, polyurethane, modified polyphenylene ether, polyphenylene sulfide, a silicone-modified resin; acrylic rubber, an acrylic thermoplastic elastomer, a silicone rubber; styrene-based thermoplastic elastomers such as SEAS, SEES, and SIS; and olefin-based rubbers such as IR, EPR, and EPDM.

The molded article of the invention contains the copolymer of the invention in an amount of preferably 80 mass %, or more, more preferably 90 mass % or more. The method for producing the molded article of the invention is not particularly limited. Examples thereof include a method in which the copolymer of the invention or a material for use in molding containing the copolymer of the invention is molded by, for example, a melt molding method such as a T-die method (such as a lamination method or a coextrusion method), an inflation method (such as a coextrusion method), a compression molding method, a blow molding method, a calendar molding method, a vacuum molding method, or an injection molding method (such as an insert method, a two-color method, a pressing method, a core back method, or a sandwich method), a solution casting method, or the like. Among these, from the viewpoint, of high productivity, cost, and the like, a T-die method, an inflation method, or an injection molding method is preferred.

The copolymer of the invention can be formed into pellets or the like in order to increase the storage, transport, or convenience when molding. Further, when obtaining the molded article of the invention, molding may be performed a plurality of times. For example, after a molded article in the form of pellets is obtained by molding the copolymer of the invention, the molded article in the form of pellets is further molded, whereby a molded article in a desired shape can be formed.

To the copolymer of the invention, according to need, various types of additives such as an antioxidant, a thermal deterioration inhibitor, a UV absorber, a light stabilizer, a lubricant, a mold release agent, a polymer processing aid, an antistatic agent, a flame retardant, a dye or pigment, a light diffusing agent, an organic pigment, a delusterant, and a fluorescent substance may be added. The blending amount of such various types of additives is preferably 7 mass % or less, more preferably 5 mass % or less, further more preferably 4 mass % or less with respect to the copolymer of the invention.

The various types of additives may be added to the polymerization reaction mixture when producing the copolymer, or may be added to the copolymer produced by the polymerization reaction, or may be added when producing the molded article.

The antioxidant has an effect of preventing oxidation deterioration of a resin by itself in the presence of oxygen. Examples thereof include a phosphorus-based antioxidant, a hindered phenol-based antioxidant, and a thioether-based antioxidant. Among these antioxidants, one type may be used alone or two or more types may be used in combination. Above all, from the viewpoint of an effect of preventing deterioration of optical characteristics due to coloration, a phosphorus-based antioxidant or a hindered phenol-based antioxidant is preferred, and the combination use of a phosphorus-based antioxidant and a hindered phenol-based antioxidant is more preferred.

In the case where a phosphorus-based antioxidant and a hindered phenol-based antioxidant are used in combination, the ratio of the amount of the phosphorus-based antioxidant used to the amount of the hindered phenol-based antioxidant used is preferably from 1:5 to 2:1, more preferably from 1:2 to 1:1 in terms of mass ratio.

As the phosphorus-based antioxidant, 2,2-methylenebis(4,6-di-t-butylphenyl)octyl phosphite (trade name: ADK STAB HP-10, manufactured by ADEKA Co., Ltd.), tris(2,4-di-t-butylphenyl) phosphite (trade name: IRGAFOS 168, manufactured by BASF Co., Ltd.), 3,9-bis(2,6-di-t-butyl-4-methylphenoxy)-2,4,8,10-tetraoxa-3,9-diphosphaspiro[5.5]undecane (trade name: ADK STAB PEP-36, manufactured by ADEKA Co. Ltd.), and the like are preferred.

As the hindered phenol-based antioxidant, pentaerythrityl-tetrakis[3-(3,5-di-t-butyl-4-hydroxyphenyl) propionate] (trade name: IRGANOX 1010, manufactured by BASF Co., Ltd.), octadecyl-3-(3,5-di-t-butyl-4-hydroxyphenyl)propionate (trade name: IRGANOX 1076, manufactured by BASF Co., Ltd.), and the like are preferred.

The thermal deterioration inhibitor can prevent thermal deterioration of a resin by trapping a polymer radical generated when the resin is exposed to a high temperature under substantially oxygen-free conditions.

As the thermal deterioration inhibitor, 2-t-butyl-6-(3′-t-butyl-5′-methyl-hydroxybenzyl)-4-methylphenyl acrylate (trade name: SUMILIZER. GM, manufactured by Sumitomo Chemical Company, Limited), 2,4-di-t-amyl-6-(3′,5′-di-t-amyl-2′-hydroxy-α-methylbenzyl) phenyl acrylate (trade name: SUMILIZER GS, manufactured by Sumitomo Chemical Company, Limited), and the like are preferred.

The UV absorber is a compound having an ability to absorb ultraviolet light, and is said to have mainly a function to convert light energy to heat energy.

Examples of the UV absorber include benzophenones, benzotriazoles, triazines, benzoates, salicylates, cyanoacrylates, oxalic anilides, malonic acid esters, and formamidines. Among these, one type may be used alone or two or more types may be used in combination.

A benzotriazole has a high effect of suppressing the decrease in optical characteristics such as coloration due to irradiation with ultraviolet light, and therefore is preferred as a UV absorber to be used in the case where a film of the invention is used for optical applications. As the benzo triazole, 2-(2H-benzotriazol-2-yl)-4-(1,1,3,3-tetramethylbutyl)phenol (trade name: TINUVIN 329, manufactured by BASF Co., Ltd.), 2-(2H-benzotriazol-2-yl)-4,6-bis(1-methyl-1-phenylethyl) phenol (trade name: TINUVIN 234, manufactured by BASF Co., Ltd.), 2,2′-methylenebis[6-(2H-benzotriazol-2-yl)-4-t-octylphenol] (LA-31, manufactured by ADEKA Ltd.), 2-(5-octylthio-2H-benzotriazol-2-yl)-6-tert-butyl-4-methyl phenol, and the like are preferred.

Further, examples of the triazine UV absorber include 2,4,6-tris(2-hydroxy-4-hexyloxy-3-methylphenyl)-1,3,5-triazine (LA-F70, manufactured by ADEKA Co. Ltd.), hydroxyphenyl triazine-based UV absorbers which are analogs thereof (TINUVIN 477 and TINUVIN 460, manufactured by BASF Co., Ltd.), and 2,4-diphenyl-6-(2-hydroxy-4-hexyloxyphenyl)-1,3,5-triazine.

Further, in the case where light with a wavelength of 380 to 400 nm is desired to be particularly effectively absorbed, it is preferred to use a metal complex including a ligand having a heterocyclic structure disclosed in WO 2011/089794, WO 2012/124395, JP-A-2012-012476, JP-A-2013-023461, JP-A-2013-112790, JP-A-2013-194037, JP-A-2014-62228, JP-A-2014-88542, JP-A-2014-88543, or the like as the UV absorber.

The light stabilizer is a compound which is said to have mainly a function to trap a radical generated by oxidation due to ht. Examples of a preferred light stabilizer include hindered amines such as a compound having a 2,2,6,6-tetraalkyl piperidine skeleton.

Examples of the lubricant include stearic acid, behenic acid, stearamide acid, methylenebis stearamide, hydroxystearic acid triglyceride, paraffin wax, ketone wax, octyl alcohol, and hydrogenated oil.

Examples of the mold release agent include higher alcohols such as cetyl alcohol and stearyl alcohol; and glycerol esters of higher fatty acids such as monoglyceride stearate and diglyceride stearate. In the invention, it is preferred to use a higher alcohol and a glycerol monoester of a fatty acid in combination as the mold release agent. In the case where a higher alcohol and a glycerol monoester of a fatty acid are used in combination, the ratio thereof is not particularly limited, however, the ratio of the amount of the higher alcohol used to the amount of the glycerol monoester of a fatty acid used is preferably from 2.5:1 to 3.5:1, more preferably from 2.8:1 to 3.2:1 in terms of mass ratio.

As the polymer processing aid, polymer particles which can be produced by an emulsion polymerization method and have a particle diameter of 0.05 to 0.5 μm are generally used. The polymer particles may be single-layer particles composed of a polymer having a single composition ratio and a single limiting viscosity, or may be multilayer particles composed of two or more polymers having different composition ratios or different limiting viscosities. Among these, particles having a two-layer structure including a polymer layer having a low limiting viscosity as an inner layer and a polymer layer having a high limiting viscosity of 5 dl/g or more as an outer layer can be exemplified as a preferred example. The polymer processing aid preferably has a limiting viscosity of 3 to 6 dl/g. When the limiting viscosity is too low, the effect of improving the moldability tends to be low. When the limiting viscosity is too high, the molding processability of the copolymer tends to be decreased.

As the organic pigment, a compound having a function to convert ultraviolet light to visible light is preferably used.

Examples of the light diffusing agent and the delusterant include glass fine particles, polysiloxane-based crosslinked fine particles, crosslinked polymer fine particles, calcium carbonate, and barium sulfate.

Examples of the fluorescent substance include a fluorescent pigment, a fluorescent dye, a fluorescent white dye, a fluorescent whitening agent, and a fluorescent bleaching agent.

A film which is one embodiment of the molded article of the invention can be produced by a solution casting method, a melt casting method, an extrusion molding method, an inflation molding method, a blow molding method, or the like. Among these, from the viewpoint that a film having excellent transparency, improved toughness, excellent handleability, and excellent balance of toughness and surface hardness and rigidity can be obtained, an extrusion molding method is preferred. The temperature of the copolymer discharged from an extruder is set to preferably 160 to 270° C., more preferably 220 to 260° C.

Among the extrusion molding methods, from the viewpoint that a film having good surface smoothness, good specular gloss, and a low haze can be obtained, a method including extruding the copolymer of the invention or a molding material composed of the copolymer of the invention in a molten state from a T-die, and subsequently performing molding by sandwiching the extruded material with two or more specular rolls or specular belts is preferred. The linear pressure between a pair of specular rolls or specular belts is preferably 10 N/mm or more, more preferably 30 N/mm or more.

Further, the surface temperatures of the specular rolls or specular belts are both preferably 130° C. or lower. In addition, the surface temperature of at least one of the pair of specular rolls or specular belts is preferably 60° C. or higher. By setting the surface temperatures in this manner, the copolymer of the invention or a molding material composed of the copolymer of the invention discharged from an extruder can be cooled at a faster rate than natural cooling, and therefore, it is easy to produce a film having excellent surface smoothness and a low haze. The thickness of an unstretched film obtained by extrusion molding is preferably from 10 to 300 μm. The haze of the film is preferably 0.5% or less, more preferably 0.3% or less when the thickness is 100 μm.

The copolymer of the invention molded into a film may be subjected to a stretching treatment. By the stretching treatment, the mechanical strength is increased, and thus, a film which is less likely to be cracked can be obtained. The stretching method is not particularly limited, and examples thereof include a simultaneous biaxial stretching method, a sequential biaxial stretching method, and a tubular stretching method. From the viewpoint that uniform stretching can be performed and a film having a high strength can be obtained, the lower limit temperature during stretching is a temperature which is higher than the glass transition temperature of the copolymer by 10° C., and the upper limit temperature during stretching is a temperature which is higher than the glass transition temperature of the copolymer 0° C. The stretching is generally performed at a rate of 100 to 5,000% per minute. By performing thermal fixing after stretching, a film with little thermal shrinkage can be obtained. The thickness of the film after stretching is preferably from 10 to 200 μm.

The film which is one embodiment of the molded article of the invention has high transparency and high heat resistance, and therefore is suitable for optical applications, and is particularly suitable for applications to a protective film for a polarizer, a protective plate for a liquid crystal, a surface material of a portable information terminal, a protective film for a display window of a portable information terminal, a light guiding film, and a front surface plate for various displays.

### EXAMPLES

Hereinafter, the invention will be more specifically described by way of Examples and Comparative Examples, however, the invention is not limited to the following Examples. Incidentally, the measurement of physical property values and the like was performed by the following methods.

### (Weight Average Molecular Weight, Number Average Molecular Weight, and Molecular Weight Distribution)

As an eluent, tetrahydrofuran was used, and as a column, a column in which two TSKgel SuperMultipore HZM-M columns and SuperHZ4000 (manufactured by Tosoh Corporation) were connected in series was used. As a GPC device, HLC-8320 (product number) (manufactured by Tosoh Corporation) equipped with a differential refractive index detector (RI detector) was used. A polymer or a copolymer (4 mg) to be measured was dissolved in 5 mL of tetrahydrofuran, whereby a sample solution was prepared. The temperature of a column oven was set to 40° C., and a chromatogram was measured by injecting 20 μL of the sample solution at an eluent flow rate of 0.35 mL/min. Ten samples of standard polystyrene having a molecular weight in the range of 400 to 5,000,000 were measured by GPC, and a calibration curve showing a relationship between a retention time and a molecular weight was created. Based on this calibration curve, a weight average molecular weight (Mw) and a number average molecular weight (Mn) were determined, and also a molecular weight distribution (Mw/Mn) was obtained.

### (Glass Transition Temperature)

A DSC curve was measured in accordance with JIS K 7121 using a differential scanning calorimeter (DSC-50 (product number), manufactured by Shimadzu Corporation) under the conditions that a polymer or a copolymer was once heated to 270° C., and then cooled to room temperature, and thereafter heated from room temperature to 270° C. at 10° C./min. A midpoint glass transition temperature obtained from the DSC curve measured in the second heating was determined to be the glass transition temperature in the invention.

### (Total Light Transmittance)

A polymer or a copolymer was hot-press molded, whereby a test piece (A) with a size of 50 mm×50 mm×3.2 mm (thickness) was obtained. The total light transmittance of the test piece (A) was measured in accordance with JIS K 7361-1 using haze meter (HM-150, manufactured by Murakami Color Research Laboratories).

### (¹H-NMR Measurement)

The confirmation of the structures of compounds synthesized in Synthesis Examples and the determination of the copolymerization compositions of copolymers of Examples and Comparative Examples were performed by ¹H-NMR. The ¹H-NMR spectrum was measured using a nuclear magnetic resonance spectrometer (Ultra Shield 400 Plus, manufactured by Bruker Corporation) at room temperature under the condition that the number of scans was set to 64 using deuterated chloroform as a solvent with respect to 10 mg of a sample.

### (Bending Elastic Modulus)

A polymer or a copolymer was hot-press molded, whereby a test piece (B) with a size of 80 mm×10 mm×4.0 mm (thickness) was obtained. By using the test piece (B), a 3-point bending test was performed at 23° C. in accordance with JIS K 7171 using an autograph (manufactured by Shimadzu Corporation), and the elastic modulus of was measured.

### (Saturated Water Absorption Coefficient)

A polymer or a copolymer was hot-press molded, whereby a test piece (B) with a size of 80 mm×10 mm×4.0 mm (thickness) was obtained. The test piece (B) was dried for 3 days in an environment of 50° C. and 667 Pa (5 mmHg), whereby a bone-dry test piece was obtained. The mass WO of the bone-dry test piece was measured. Thereafter, the bone-dry test piece was immersed in water at a temperature of 23° C. and left for 2 months. The test piece was pulled up from water, and the mass W1 of the test piece was measured. The saturated water absorption coefficient (%) was calculated according the following formula.

Saturated water absorption coefficient={(W1−W0)/W0}×100

### (Pencil Hardness)

A polymer or a copolymer was hot-press molded, whereby a test piece (A) with a size of 50 mm×50 mm×3.2 mm (thickness) was obtained. The pencil hardness of the obtained test piece (A) was measured in accordance with JIS K 5600-5-4 under a load 0.75 kg.

### (Thermal Decomposition Temperature)

A thermal mass analysis (TG) of a polymer or a copolymer was performed in a nitrogen atmosphere in accordance with JIS K 7120 at a temperature increase rate of 10° C./rain. The weight at 250° C. was used as the original point, and a temperature at which the weight was decreased by 1% was determined as “thermal decomposition temperature”. As the measurement device, TGA-50 (product number) manufactured by Shimadzu Corporation was used.

### Synthesis Example 1

### Synthesis of 2-ethinylcyclopentanol (i)

A 10-L four-necked flask equipped with a thermometer, a stirrer, a dropping funnel, and a nitrogen inlet tube was charged with 163 g (1.80 mol) of lithium acetylide-ethylenediamine complex, and then, 5 L of dimethyl sulfoxide was fed thereto through the dropping funnel. Then, 126 g (1.50 mol) of cyclopentene oxide was added dropwise thereto at a rate capable of maintaining the internal temperature at 40° C. or lower. After completion of the dropwise addition, the internal temperature was raised to 75° C., and then, the mixture was heated and stirred for 4 hours. After the reaction mixture was cooled to 25° C., 0.5 L of a saturated aqueous solution of ammonium chloride and 2 L of a saturated saline solution were added thereto through the dropping funnel. The resulting mixed liquid was subjected to extraction twice with 2 L of diisopropyl ether, and the organic layer was concentrated under reduced pressure. The resulting concentrated liquid was purified by silica gel column chromatography, whereby 107 g (0.98 mol) of 2-ethinylcyclopentanol was obtained (yield: 65%).

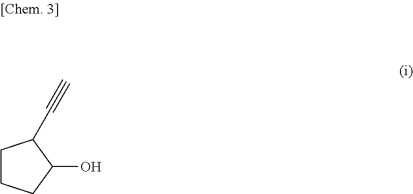

When the ¹H-NMR of the obtained purified product (2-ethinylcyclopentanol) was measured, the ¹H-NMR chart was as follows.

¹H-NMR (400 MHz, CDCl₃, TMS, ppm) δ: 4.0-4.4 (1H, m), 3.1 (1H, s), 2.4-2.8 (1H, m), 2.1 (1H, d, J=2.6 Hz), 1.4-2.3 (6H, m)

### Synthesis Example 2

### Synthesis of 2-ethinylcyclohexanol (ii)

The same reaction procedure as in Synthesis Example 1 was performed except that 147 g (1.50 mol) of cyclohexene oxide was used in place of 126 g (1.50 mol) of cyclopentene oxide, whereby 130 g (1.05 mol) of 2-ethinylcyclohexanol was obtained (yield: 70%).

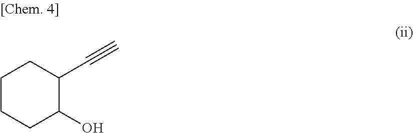

When the ¹H-NMR of the obtained purified product (2-ethinylcyclohexanol) was measured, the ¹H-NMR chart was as follows.

¹H-NMR (400 MHz, CDCl₃, TMS, ppm) δ: 3.48-3.42 (1H, m), 2.28 (1H, s), 2.23-2.15 (1H, m), 2.14 (1H, d, J=2.4 Hz) 2.03-1.11 (8H, m)

### Synthesis Example 3

### Synthesis of hexahydro-3-methylene-2H-cyclopenta[b]furan-2-one (iii)

A 5,000-mL autoclave equipped with a stirrer, a thermometer, a gas inlet tube, and a gas outlet tube was charged with 63.3 g (575 mmol) of 2-ethinylcyclopentanol obtained in Synthesis Example 1, 2,500 mL of acetonitrile, 39.3 g (222 mmol) of palladium chloride, 41.8 g (221 mmol) of tin(II) chloride, and 90.3 g (446 mmol) of tri-n-butylphosphine. Carbon monoxide was introduced from the gas inlet tube, and the mixture was pressurized to 0.8 MPa. While continuing pressurization with carbon monoxide, the mixture was heated and stirred at 75° C. for 15 hours. After the mixture was cooled to 25° C., carbon monoxide was discharged from the gas outlet tube. To the resulting reaction mixture, 1.7 L of water and 5 L of ethyl acetate were added, and the mixture was filtered using celite. This filtrate was allowed to separate, and the resulting organic layer was concentrated under reduced pressure. This concentrated liquid was purified using silica gel column chromatography, whereby 27.0 g (196 mmol) of hexahydro-3-methylene-2H-cyclopenta[b]furan-2-one (hereinafter referred to as “MCPBL”) was obtained (yield: 34%).

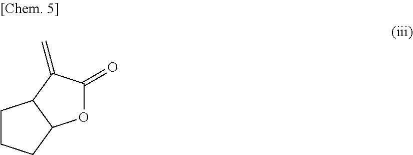

When the ¹H-NMR of the obtained purified product (hexahydro-3-methylene-2H-cyclopenta[b]furan-2-one) was measured, the ¹H-NMR chart was as follows.

¹H-NMR (400 MHz, CDCl₃, TMS, ppm) δ: 6.05 (1H, d, J=3 Hz), 5.45 (1H, d, J=4 Hz), 3.71 (1H, m), 2.62 (1H, m), 2.42-1.20 (6H, m)

### Synthesis Example 4

### Hexahydro-3-methylene-2(3H)-benzofuranone (iv)

The same procedure as in Synthesis Example 3 was performed except that 71.4 g (575 mmol) of 2-ethinylcyclohexanol obtained in Synthesis Example 2 was used in place of 63.3 g (575 mmol) of 2-ethinylcyclopentanol, whereby 33.3 (219 mmol) of hexahydro-3-methylene-2(3H)-benzofuranone (hereinafter referred to as “MCHBL”) was obtained (yield: 38%).

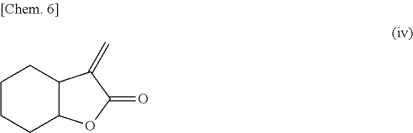

When the ¹H-NMR of the obtained purified product (hexahydro-3-methylene-2(3H)-benzofuranone) was measured, the ¹H-NMR chart was as follows.

¹H-NMR (400 MHz, CDCl₃, TMS, ppm) δ: 6.06 (1H, d, J=3 Hz), 5.39 (1H, d, J=3 Hz), 3.72 (1H, m), 2.45 (1H, m), 2.41-1.33 (8H, m)

### Example 1

The inside of a sufficiently dried pressure resistant vessel equipped with a stirrer was purged with nitrogen. The pressure resistant vessel was charged with 47.4 parts by mass of methyl methacrylate, 12 parts by mass of MCHBL obtained in Synthesis Example 4, and 0.0825 parts by mass of n-octyl mercaptan with respect to 15 parts by mass of toluene.

After the pressure resistant vessel was sufficiently purged with nitrogen gas, the temperature was raised to 140° C. while stirring. The total amount of 0.00188 parts by mass of di-t-butyl peroxide (PEREUTYL D, manufactured by NOF Corporation) dissolved in 1 part by mass of toluene was added to the pressure resistant vessel, and polymerization was started. At 4 hours after the start of polymerization, the mixture was cooled to room temperature to stop the polymerization. The resulting solution was diluted by adding 50 parts by mass of toluene thereto, and thereafter, the diluted liquid was poured in 4,000 parts by mass of methanol to deposit a solid material. The deposited solid material was separated by filtration, and then sufficiently dried, whereby 26 parts by mass of a copolymer (A1) was obtained. When the ¹H-NMR of the copolymer (A1) was measured, the content of the structural unit derived from methyl methacrylate was 85.9 mass %, and the content of the structural unit derived from MCHBL was 14.1 mass %. The copolymer (A1) had a weight average molecular weight (Mw) of 204,000 and a molecular weight distribution (Mw/Mn) of 2.27. The other evaluation results are shown in Table 1.

### Example 2

Parts by mass of a copolymer (A2) was obtained in the same manner as in Example 1 except that the pressure resistant vessel was charged with 29.4 parts mass of methyl methacrylate, 30 parts by mass of MCHBL obtained in Synthesis Example 4, and 0.0375 parts by mass of n-octyl mercaptan with respect to 15 parts by mass of toluene. When the ¹H-NMR of the copolymer (A2) was measured, the content of the structural unit derived from methyl methacrylate was 57.5 mass %, and the content of the structural unit derived from MCHBL was 42.5 mass %. The copolymer (A2) had a weight average molecular weight (Mw) of 222,000 and a molecular weight distribution (Mw/Mn) of 2.33. The other evaluation results are shown in Table 1.

### Example 3

28 Parts by mass of a copolymer (A3) was obtained in the same manner as in Example 1 except that the pressure resistant vessel was charged with 17.4 parts by mass of methyl methacrylate, 42 parts by mass of MCHBL obtained in Synthesis Example 4, and 0.0825 parts by mass of n-octyl mercaptan with respect to 15 parts by mass of toluene. When the ¹H-NMR of the copolymer (A3) was measured, the content of the structural unit derived from methyl methacrylate was 36.4 mass %, and the content of the structural unit derived from MCHBL was 63.6 mass %. The copolymer (A3) had a weight average molecular weight (Mw) of 171,000 and a molecular weight distribution (Mw/Mn) of 2.39. The other evaluation results are shown in Table 1.

### Example 4

Parts by mass of a copolymer (A4) was obtained in the same manner as in Example 1 except that the pressure resistant vessel was charged with 42 parts by mass of methyl methacrylate, 7.5 parts by mass of MCHBL obtained in Synthesis Example 4, and 0.040 parts by mass of n-octyl mercaptan with respect to 50 parts by mass of toluene. When the ¹H-NMR of the copolymer (A4) was measured, the content of the structural unit derived from methyl methacrylate was 83.5 mass %, and the content of the structural unit derived from MCHBL was 16.5 mass %. The copolymer (A4) had a weight average molecular weight (Mw) of 120,000 and a molecular weight distribution (Mw/Mn) of 1.1.91. The other evaluation results are shown in Table 1.

### Example 5

24 Parts by mass of a copolymer (A5) was obtained in the same manner as in Example 1 except that MCPBL obtained in Synthesis Example 3 was charged in place of MCHBL. When the ¹H-NMR of the copolymer (A5) was measured, the content of the structural unit derived from methyl methacrylate was 84.7 mass %, and the content of the structural unit derived from MCPBL was 15.3 mass %. The copolymer (A5) had a weight average molecular weight (Mw) of 220,000 and a molecular weight distribution (Mw/Mn) of 2.21. The other evaluation results are shown in Table 1.

### Example 6

19 Parts by mass of a copolymer (A6) was obtained in the same manner as in Example 2 except that MCPBL obtained in Synthesis Example 3 was charged in place of MCHBL. When the ¹H-NMR of the copolymer (A6) was measured, the content of the structural unit derived from methyl methacrylate was 55.2 mass %, and the content of the structural unit derived from MCPBL was 44.8 mass %. The copolymer (A6) had a weight average molecular weight (Mw) of 276,000 and a molecular weight distribution (Mw/Mn) of 2.19. The other evaluation results are shown in Table 1.

### Example 7

The inside of a sufficiently dried pressure resistant vessel equipped with a stirrer was purged with nitrogen. The pressure resistant vessel was charged with 47.4 parts by mass of styrene and 12 parts by mass of MCHBL obtained in Synthesis Example 4 with respect to 15 parts by mass of toluene.

After the pressure resistant vessel was sufficiently purged with nitrogen gas, the temperature was raised to 130° C. while stirring. The total amount of 0.0021 parts by mass of di-t-butyl peroxide (PEREUTYL D, manufactured by NOF Corporation) dissolved in 1 part by mass of toluene was added to the pressure resistant vessel, and polymerization was started. At 3 hours after the start of polymerization, the mixture was cooled to room temperature to stop the polymerization. The resulting solution was diluted by adding 50 parts by mass of toluene thereto, and thereafter, the diluted liquid was poured in 4,000 parts by mass of methanol to deposit a solid material. The deposited solid material was separated by filtration, and then sufficiently dried, whereby 15 parts by mass of a copolymer (A7) was obtained. When the ¹H-NMR of the copolymer (A7) was measured, the content of the structural unit derived from styrene was 66.3 mass %, and the content of the structural unit derived from MCHBL was 33.7 mass %. The copolymer (A7) had a weight average molecular weight (Mw) of 111,100 and a molecular weight distribution (Mw/Mn) of 2.13. The other evaluation results are shown in Table 1.

### Example 8

17 Parts by mass of a copolymer (A8) was obtained in the same manner as in Example 7 except that the pressure resistant vessel was charged with 29.4 parts by mass of styrene and 30 parts by mass of MCHBL obtained in Synthesis Example 4 with respect to 15 parts by mass of toluene. When the ¹H-NMR of the copolymer (A8) was measured, the content of the structural unit derived from styrene was 37.0 mass %, and the content of the structural unit derived from MCHBL was 63.0 mass %. The copolymer (A8) had a weight average molecular weight (Mw) of 143,500 and a molecular weight distribution (Mw/Mn) of 2.06. The other evaluation results are shown in Table 1.

### Comparative Example 1

33 Parts by mass of a copolymer (B1) was obtained in the same manner as in Example 2 except that the pressure resistant vessel was charged with 69.3 parts by mass methyl methacrylate and 0.084 parts by mass of n-octyl mercaptan with respect to 17.5 parts by mass of toluene, but was not charged with MCHBL. When the ¹H-NMR of the copolymer (31) was measured, the content of the structural unit derived from methyl methacrylate was 100 mass %. The copolymer (B1) had a weight average molecular weight (Mw) of 176,000 and a molecular weight distribution (Mw/Mn) of 2.02. The other evaluation results are shown in Table 1.

### Comparative Example 2

23 Parts by mass of a copolymer (32) was obtained in the same manner as in Example 2 except that α-methylene-γ-butyrolactone (manufactured by Tokyo Chemical Industry Ltd.) (hereinafter abbreviated as “MBL”) was charged in place of MCHBL. When the ¹H-NMR of the copolymer (B2) was measured, the content of the structural unit derived from methyl methacrylate was 41.7 mass % and the content of the structural unit derived from MBL was 58.3 mass %. The copolymer (B2) had a weight average molecular weight (Mw) of 544,000 and a molecular weight distribution (Mw/Mn) of 2.50. Incidentally, the copolymer (B2) was not dissolved in THF, and therefore was dissolved in a DMF solvent, and Mw and Mw/Mn were measured by GPC using a DMF solvent. The other evaluation results are shown in Table 1.

### Example 9

The inside of a sufficiently dried pressure resistant vessel equipped with a stirrer was purged with nitrogen. The pressure resistant vessel was charged with 100 g of toluene, 1.4 g (6.0 mmol) of 1,1,4,7,10,10-hexamethyltriethylenetetramine, 29.7 g (17 mmol) a toluene solution of isobutyl bis(2,6-di-t-butyl-4-methylphenoxy)aluminum at a concentration of 0.45 M, and 4.5 g (5.7 mmol) of a solution of sec-butyllithium at a concentration of 1.3 M (solvent: 95 mass % cyclohexane and 5 mass % n-hexane) at room temperature. While stirring, a mixture of 10 g of methyl methacrylate purified by distillation and 10 g of MCHBL obtained in Synthesis Example 4 was added dropwise thereto at 20° C. over 30 minutes. After completion of the dropwise addition, the mixture was stirred at 20° C. for 90 minutes.

The resulting solution was diluted by adding 100 g of toluene thereto. Then, the diluted liquid was poured in 2 kg of methanol to deposit solid material. The deposited solid material was separated by filtration, and then sufficiently dried, whereby 16 parts by mass of a copolymer (A9) was obtained. When the ¹H-NMR of the copolymer (A9) was measured, the content of the structural unit derived from methyl methacrylate was 60.6 mass %, and the content of the structural unit derived from MCHBL was 39.4 mass %. The copolymer (A9) had a weight average molecular weight (Mw) of 4,800 and a molecular weight distribution (Mw/Mn) of 1.31. The other evaluation results are shown in Table 2.

### Comparative Example 3

17 Parts by mass of a polymer (B3) was obtained in the same manner as in Example 9 except that 20 g of methyl methacrylate was used in place of 10 of methyl methacrylate and 10 g of MCHBL obtained in Synthesis Example 4. When the ¹H-NMR of the polymer (B3) was measured, the content of the structural unit derived from methyl methacrylate was 100 mass %. The polymer (B3) had a weight average molecular weight (Mw) of 4,000 and a molecular weight distribution (Mw/Mn) of 1.28. The other evaluation results are shown in Table 2.

TABLE 1

| | | Example 1 | Example 2 | Example 3 | Example 4 | Example 5 |
|---|---|---|---|---|---|---|
| | | A1 | A2 | A3 | A4 | A5 |
| Composition of copolymer (mass %) | | | | | | |
| Monomer represented | MCHBL | 14.1 | 42.5 | 63.6 | 16.5 | |
| by formula (1) | MCPBL | | | | | 15.3 |
| Other monomer | MMA | 85.9 | 57.5 | 36.4 | 83.5 | 84.7 |
| | St | | | | | |
| | MBL | | | | | |
| Molecular weight of copolymer | | | | | | |
| Weight average | g/mol | 204,000 | 222,000 | 171,000 | 120,000 | 220,000 |
| molecular weight | | | | | | |
| Mw/Mn | | 2.27 | 2.33 | 2.39 | 1.91 | 2.21 |
| Physical property values of | | | | | | |
| copolymer | | | | | | |
| Glass transition | ° C. | 137 | 192 | 244 | 145 | 136 |
| temperature | | | | | | |
| Bending elastic | MPa | 3300 | 3500 | 3500 | 3400 | 3300 |
| modulus | | | | | | |
| Total light transmittance | % | 92 | 92 | 91 | 92 | 92 |
| Water absorption | % | 2.3 | 2.8 | 3.3 | 2.4 | 2.4 |
| coefficient | | | | | | |
| Pencil hardness | | 3H | 3H | 3H | 3H | 3H |
| Thermal decomposition | ° C. | 325 | 330 | 338 | 318 | 310 |
| temperature | | | | | | |
| | | | | | Comparative | Comparative |
| | | Example 6 | Example 7 | Example 8 | Example 1 | Example 2 |
| | | A6 | A7 | A8 | B1 | B2 |
| Composition of copolymer (mass %) | | | | | | |
| Monomer represented | MCHBL | | 33.7 | 63.0 | | |
| by formula (1) | MCPBL | 44.8 | | | | |
| Other monomer | MMA | 55.2 | | | 100 | 41.7 |
| | St | | 66.3 | 37.0 | | |
| | MBL | | | | | 58.3 |
| Molecular weight of copolymer | | | | | | |
| Weight average | g/mol | 276,000 | 111,100 | 143,500 | 176,000 | 544,000 |
| molecular weight | | | | | | |
| Mw/Mn | | 2.19 | 2.13 | 2.06 | 2.02 | 2.50 |
| Physical property values of | | | | | | |
| copolymer | | | | | | |
| Glass transition | ° C. | 190 | 146 | 203 | 120 | 158 |
| temperature | | | | | | |
| Bending elastic | MPa | 3500 | 3800 | 4000 | 3100 | 4700 |
| modulus | | | | | | |
| Total light transmittance | % | 92 | 91 | 91 | 92 | 92 |
| Water absorption | % | 3.0 | 1.1 | 2.0 | 1.9 | 4.1 |
| coefficient | | | | | | |
| Pencil hardness | | 3H | 3H | 3H | 3H | 3H |
| Thermal decomposition | ° C. | 334 | 343 | 362 | 326 | 313 |
| temperature | | | | | | |

TABLE 2

| | | | Comparative |
|---|---|---|---|
| | | Example 9 | Example 3 |
| | | A9 | B3 |
| Composition of copolymer (mass %) | | | |
| Monomer represented by | MCHBL | 39.4 | |
| formula (1) | | | |
| Other monomer | MMA | 60.6 | 100 |
| Molecular weight of copolymer | | | |
| Weight average molecular | g/mol | 4,800 | 4,000 |
| weight | | | |
| Mw/Mn | | 1.31 | 1.28 |
| Physical property value of copolymer | | | |
| Glass transition temperature | ° C. | 137 | 74 |

As can be seen from Table 1, found that all the copolymers containing the structural unit derived from the monomer represented by the formula (1) have high heat resistance. From Example 2 and Comparative Example 2, it is found that not only the heat resistance is higher, but also the water absorption coefficient is lower as compared with the copolymer obtained by copolymerization of conventionally known MBL.

From the Examples, it is found that the monomer represented by the formula (1) has favorable copolymerizability with MMA and styrene.

The Examples show that the monomer represented by the formula (1) enables not only radical polymerization, but also anionic polymerization, and therefore, various production methods according to the type of desired copolymer can be selected.

1: A copolymer comprising a structural unit derived from a monomer represented by the following formula (1) and a structural unit derived from another monomer (A): 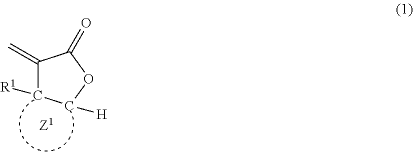
wherein
the ring Z¹ represents a C3-10 ring structure optionally having an oxygen atom at any position formed together with two carbon atoms on γ-butyrolactone, and
R¹ represents a hydrogen atom or a C1-10 alkyl group.

2: The copolymer according to claim 1, wherein the other monomer (A) comprises at least a methacrylic acid ester.

3: The copolymer according to claim 1, wherein the structural unit derived from the monomer represented by the formula (1) is comprised in an amount of 12 to 70 mass %.

4: A molded article comprising the copolymer according to claim 1.

5: The copolymer according to claim 1, wherein the ring Z¹ represents a C6 ring structure formed together with two carbon atoms on γ-butyrolactone.

6: The copolymer according to claim 1, wherein the monomer represented by the following formula (1) is hexahydro-3-methylene-2(3H)-benzofuranone.

7: The copolymer according to claim 1, wherein a weight average molecular weight of the copolymer of is from 40,000 to 300,000.

8: The copolymer according to claim 1, wherein the structural unit derived from the monomer represented by the formula (1) is comprised in an amount of less than 42.5 mass %.

9: The copolymer according to claim 1, wherein a glass transition temperature of the copolymer is less than 145° C.

10: A film, comprising the molded article according to claim 4.

11: The film according to claim 10, wherein a thickness of the film is from 10 to 300 μm.
